(19) United States
(12) Patent Application Publication
(10) Pub. No.: US 2012/0115517 A1
(43) Pub. Date: May 10, 2012

(54) AD HOC MOBILE DEVICES AND AD HOC NETWORKS

(75) Inventors: Andreas IBING, Berlin (DE); Holger Boche, Berlin (DE)

(73) Assignee: Technische Universität Berlin

(21) Appl. No.: 12/941,861

(22) Filed: Nov. 8, 2010

(51) Int. Cl. H04W 88/02; H04W 84/18

(52) U.S. Cl. 455/500; 455/73

(57) ABSTRACT

The present invention relates to ad hoc mobile devices and to ad-hoc networks.

An embodiment of the invention relates to an ad hoc mobile device capable of transmitting and receiving data in an ad-hoc network, comprising a receiver capable of receiving and decoding an encoded signal which is transmitted over a physical transmission channel, wherein said receiver is able to handle at least two different code structures; a transmitter capable of generating and transmitting an encoded signal, wherein said transmitter is able to handle at least two different code structures; and a control unit which is connected to said receiver and said transmitter, said control unit being able to change the code structure currently used by the receiver and the transmitter.

### BACKGROUND OF THE INVENTION

The present invention relates to ad hoc mobile devices and ad-hoc networks.

Ad hoc networks are self-configuring networks of mobile devices connected by wireless links. Each mobile device is free to move independently in any direction, and will therefore change its links to other devices frequently.

The data transmission in today's ad-hoc networks is strongly limited by interference.

### OBJECTIVE OF THE PRESENT INVENTION

An objective of the present invention is to provide an ad hoc mobile device which is capable of reducing negative effects of interfering signals on ongoing communication.

A further objective of the present invention is to provide an ad hoc network which is capable of reducing negative effects of interfering signals on ongoing communication.

A further objective of the present invention is to provide a method of handling a data connection between a first and a second ad hoc mobile device in an ad hoc network in order to reduce negative effects of interfering signals on ongoing communication.

### BRIEF SUMMARY OF THE INVENTION

An embodiment of the invention relates to an ad hoc mobile device capable of transmitting and receiving data in an ad-hoc network, comprising a receiver capable of receiving and decoding an encoded signal which is transmitted over a physical transmission channel, wherein said receiver is able to handle at least two different code structures; a transmitter capable of generating and transmitting an encoded signal, wherein said transmitter is able to handle at least two different code structures; and a control unit which is connected to said receiver and said transmitter, said control unit being able to change the code structures currently used by the receiver and the transmitter.

Preferably, the device is configured to agree with another ad hoc mobile device on a code structure to be used for further communication. Such an agreement may be found by exchanging code structure information via data and/or control data packets.

The device may be configured to establish a data connection with another ad hoc mobile device based on a predefined default code structure, and to switch from the default code structure to a different code structure thereafter to transmit or receive an encoded signal to/from the other ad hoc mobile device based on said different code structure.

Further, the device is preferably configured to select the different code structure and to signal the selected code structure to the other ad hoc mobile device for the subsequent data transfer.

The device may be further configured to receive a control signal that defines said different code structure, from the other ad hoc mobile device, and to switch its receiver to said different code structure for further data reception.

The device may be configured to change the code structure by carrying out one or more of the following steps: selecting a code polynomial out of a plurality of predefined code polynomials; selecting a turbo-interleaver or a turbo-deinterleaver out of a plurality of predefined turbo-interleavers or turbo-deinterleavers; selecting a channel-interleaver or a channel-deinterleaver out of a plurality of predefined channel-interleavers or channel-deinterleavers; selecting a channel class out of a plurality of predefined channel classes; selecting a scrambling rule out of a plurality of predefined scrambling rules; and/or selecting a permutation for symbol mapping to subcarriers.

Preferably, the receiver comprises a decoder capable of handling the at least two different code structures. The transmitter preferably comprises an encoder capable of handling the at least two different code structures. The control unit is preferably connected to the encoder and the decoder to change the code structure currently used by the encoder and/or the decoder.

The ad hoc mobile device may be capable of communicating based on a RTS/CTS scheme. Preferably, the device is capable of sending a Clear-To-Send(CTS) Request to another ad hoc mobile device after receiving a Request-To-Send(RTS)-signal from said other ad hoc mobile device, said Request To Send(RTS)-signal being sent based on a default code structure and containing information defining a different code structure for further data transfer.

A further embodiment of the present invention relates to an ad-hoc network comprising at least two ad hoc mobile devices as described above.

Preferably said at least two ad hoc mobile devices communicate with each other based on a code structure previously agreed on.

A further embodiment of the present invention relates to a method of handling a data connection between a first and a second ad hoc mobile device, the method comprising the steps of: establishing a data connection between said first and said second ad hoc mobile device based on a predefined default code structure; agreeing on a different code structure; and switching said first and said second ad hoc mobile device from the default code structure to a different code structure to transmit or receive a decoded signal based on said different code structure.

### BRIEF DESCRIPTION OF THE DRAWINGS

In order that the manner in which the above-recited and other advantages of the invention are obtained will be readily understood, a more particular description of the invention briefly described above will be rendered by reference to specific embodiments thereof which are illustrated in the appended figures and tables. Understanding that these figures and tables depict only typical embodiments of the invention and are therefore not to be considered to be limiting of its scope, the invention will be described and explained with additional specificity and detail by the use of the accompanying drawings in which

FIG. 1 shows an exemplary embodiment of a first ad-hoc mobile device and a second ad-hoc mobile device;

FIGS. 2-4 show log-likelihood ratio density distributions of a QPSK signal embedded in QPSK interference and Gaussian noise having different receive power ratios; and

FIG. 5-6 show the first and second ad-hoc mobile device during communication in RTS/CTS mode in an exemplary fashion.

### DETAILED DESCRIPTION OF THE PREFERRED EMBODIMENTS

The preferred embodiments of the present invention will be best understood by reference to the drawings, wherein identical or comparable parts are designated by the same reference signs throughout.

It will be readily understood that the present invention, as generally described herein, could vary in a wide range. Thus, the following more detailed description of the exemplary embodiments of the present invention, is not intended to limit the scope of the invention, as claimed, but is merely representative of presently preferred embodiments of the invention.

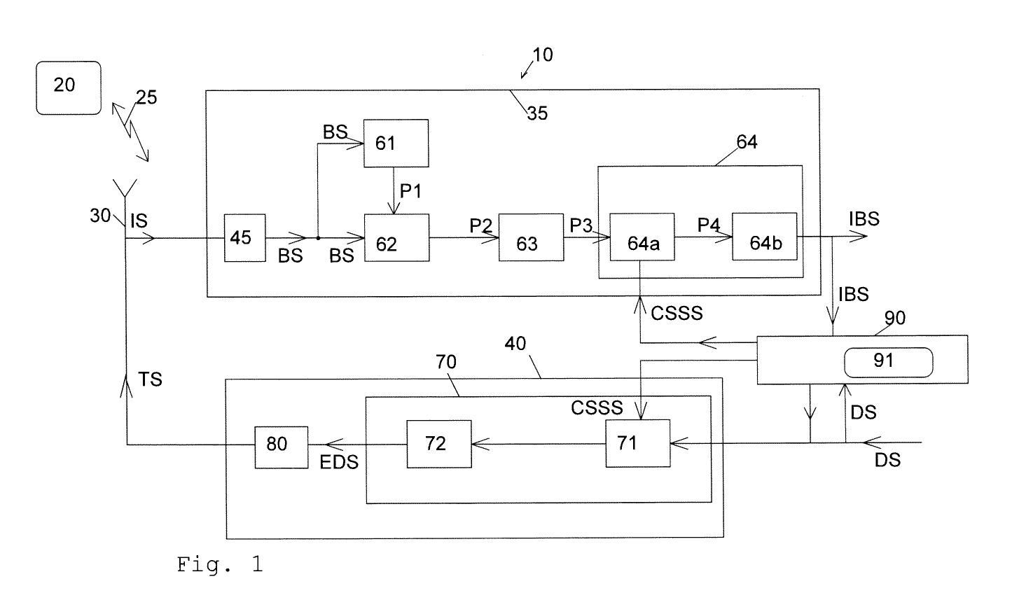

FIG. 1 shows an exemplary embodiment of a first ad hoc mobile device 10 which transmits and receives data to/from a second ad-hoc mobile device 20 over a physical transmission channel 25. The first device 10 inter alia comprises an antenna 30, a receiver 35, and a transmitter 40.

The receiver 35 is configured to receive and decode an encoded and modulated bitstream contained in the incoming signal IS, which is received over the physical transmission channel 25. To this end, the receiver 35 comprises a down-converter unit 45 for down-conversion and digitization. The down-converter unit 45 is configured to down-convert and digitize the incoming signal IS and to provide an incoming baseband complex symbol stream BS.

The receiver 35 further comprises a channel estimator 61 which provides estimated channel samples P1. The estimated channel samples P1 describe channel distortions imposed to the encoded and modulated bitstream by the physical transmission channel 25. Channel estimators are known in the art (e.g. “OFDM and MC-CDMA for Broadband Multi-User Communications, WLANs and Broadcasting,” L. Hanzo, M. Munster, B. Choi and T. Keller, Wiley—IEEE Press, September 2003).

An equalizer 62 of the receiver 35 equalizes the baseband complex symbol stream BS and provides a first equalized symbol stream P2. The equalizer 62 provides the equalized symbol stream P2 by calculating a deconvolution between the estimated channel samples P1 generated by the channel estimator 61, and the baseband complex symbol stream. BS.

A demapper 63 of the receiver 35 processes the equalized symbol stream P2 and provides a log-likelihood ratio (LLR) stream P3.

A decoder 64 of the receiver 35 comprises a soft-input-soft-output decoder unit 64a and a converter unit 64b. The soft-input-soft-output decoder unit 64a processes the log-likelihood ratio stream P3 and provides a decoded log-likelihood ratio stream P4.

The decoded log-likelihood ratio stream P4 is converted to a bitstream IBS by the converter unit 64b of decoder 64. As such, the bitstream IBS comprises the data bits transmitted by the encoded and modulated bitstream and contained in the incoming signal IS.

The transmitter 40 of the first device 10 comprises an encoding unit 70, and an up-converter unit 80 for digital/analog-conversion and up-conversion.

The transmitter 40 is configured to process an outgoing data bitstream DS and to generate an encoded and modulated bitstream TS for transmission over the physical transmission channel 25. The encoded and modulated bitstream TS is sent to the second device 20. To this end, the encoding unit 70 comprises an encoder 71 and a mapper 72, which both encode the data bitstream DS and generate an encoded outgoing baseband complex symbol stream EDS. The outgoing baseband complex symbol stream EDS is digital/analog-converted and up-converted by the up-converter unit 80 in order to generate the transmission signal TS. The transmission signal TS is transmitted via the antenna 30 to the second ad hoc mobile device 20.

The receiver 35 and the transmitter 40 are both able to handle a plurality of different code structures. As can be seen in FIG. 1, the soft-input-soft-output decoder 64a and the encoder 71 are connected to a control unit 90 which is able to change the code structure currently applied by the soft-input-soft-output decoder 64a and/or the encoder 71. To this end, the control unit 90 may transmit a code structure selection signal CSSS to the soft-input-soft-output decoder 64a and/or the encoder 71.

In order to determine a code structure for communication, the control unit 90 evaluates the incoming bitstream IBS and/or the outgoing data bitstream DS, depending on the communication status and communication scheme. If the control unit 90 determines that a new code structure needs to be selected, its code structure selection unit 91 preferably selects the appropriate code structure by selecting a code polynomial out of a plurality of predefined code polynomials, by selecting a turbo-interleaver or a turbo-deinterleaver out of a plurality of predefined turbo-interleavers or turbo-deinterleavers, by selecting a channel-interleaver or a channel-deinterleaver out of a plurality of predefined channel-interleavers or channel-deinterleavers, by selecting a channel class out of a plurality of predefined channel classes, by selecting a scrambling process and/or permutation process for subcarrier mapping.

Preferably, the control unit 90 agrees with each ad hoc mobile device, which communicates with the device 10, on an individual code structure for their individual communication. The use of individual code structures randomizes the interference and avoids amplification of interference during decoding. This will be explained in further detail below:

Most decoders like decoder 64 in FIG. 1 show an amplification behavior which is approximately linear. As such, a log-likelihood ratio (LLR) vector component caused by interference with the same code structure will be amplified with the coding gain of the decoder, i.e. in the same manner and to the same extent as the “wanted” signal. In other terms, the interfering signal will be treated like the wanted signal and will be amplified with the coding gain. Thus, the signal-to-interference-ratio (SIR) will remain unchanged, and—depending on the current SIR-value—proper decoding of the wanted signal might be impaired.

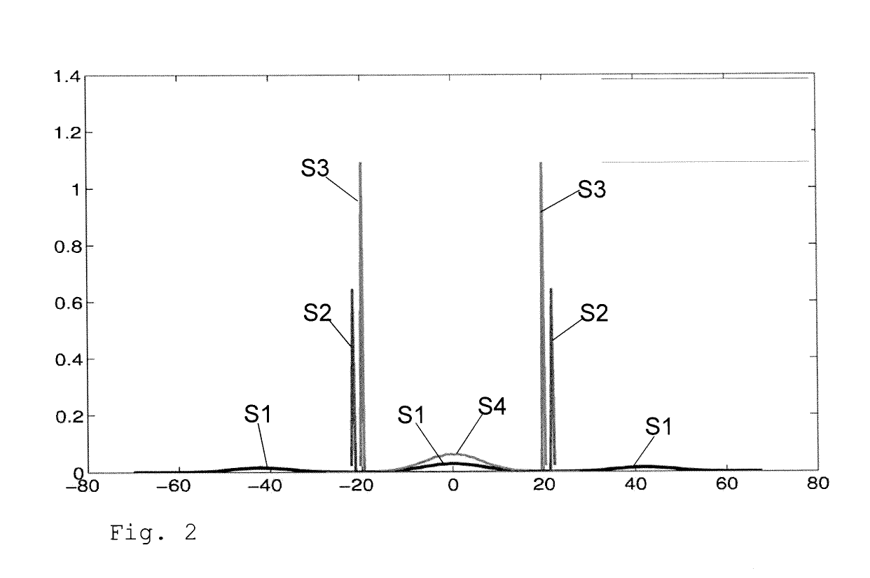

In contrast thereto, if the code structures are randomized over the channels (and over the pairs of ad hoc mobile devices), it is more likely that interfering channels will significantly differ in their code structure from the code structure of the wanted signal. Thus, the LLR vector components caused by interference will not be amplified with the coding gain of the decoder, or at least not to the same extent. Thus, the signal-to-interference-ratio (SIR) will increase during decoding, and proper decoding of the wanted signal will be more likely. It is even possible to enable proper decoding in cases where the SIR-value before decoding (after mapping) is smaller than one (below zero measured in dB). FIGS. 2-4 show an example where the step of decoding increases the SIR-value from below 0 dB before decoding to a value much higher than 0 dB after decoding.

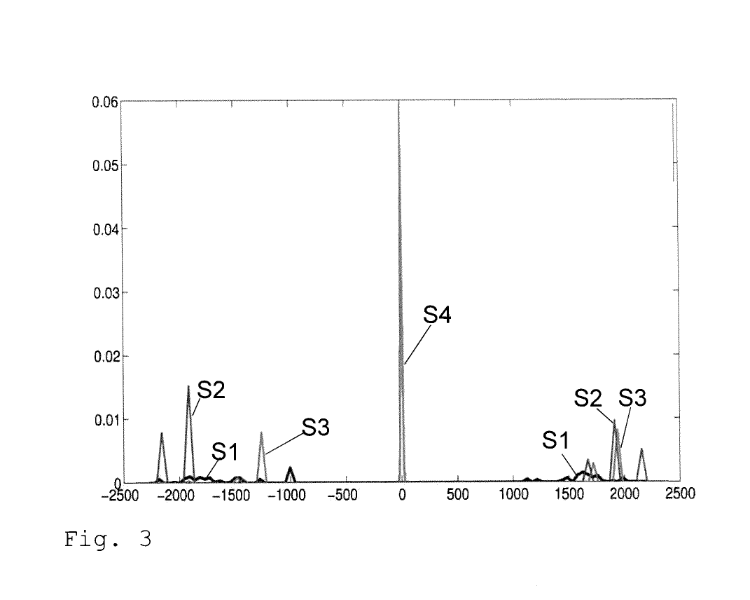

FIG. 2 shows the log-likelihood-ratio (LLR) density distribution of a QPSK signal having a SIR-value of −1.7 dB and a SNR (signal-noise-ratio) of 10 dB after demapping. The log-likelihood-ratio (LLR) density distribution as shown in FIG. 2 corresponds to signal P3 in FIG. 1 which is generated by demapper 63. In FIG. 3, reference sign S3 refers to the wanted signal, reference sign S2 refers to the interference (interfering) signal, reference sign S4 refers to noise, and reference sign S1 refers to the joint signal.

If the interfering signal S2 uses the same code structure as the wanted QPSK signal S3, the decoder 64 will fail to generate a properly decoded signal as the interfering signal S2 experiences the same decoder gain as the wanted signal S3. Thus, the SIR-value remains at approximately −1.7 dB and decoding will not be possible. This is shown in FIG. 3 in an exemplary fashion. FIG. 3 shows the log-likelihood-ratio (LLR) density distribution after decoding by the soft-input-soft-output decoder 64a. The log-likelihood-ratio (LLR) density distribution of FIG. 3 is contained in signal P4 of FIG. 1.

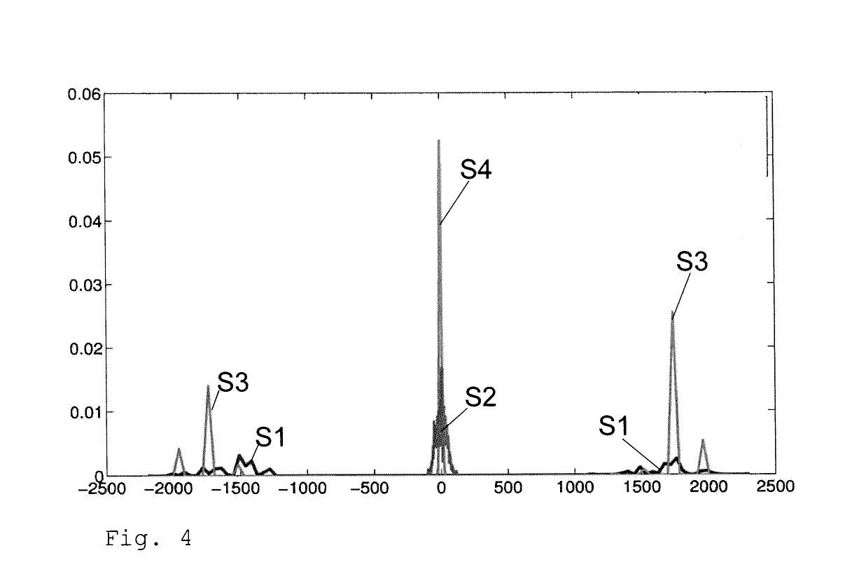

However, if the interfering signal S2 uses a code structure differing from the one of the wanted QPSK signal S3, the decoder 64 will be able to generate a properly decoded signal since the interfering signal S2 will not be amplified at all, or at least much less than the wanted signal S3. Thus, the SIR-value will significantly increase during decoding, and a properly decoded signal may be generated. This is shown in FIG. 4 in an exemplary fashion. Again, the log-likelihood-ratio (LLR) density distribution is shown after decoding.

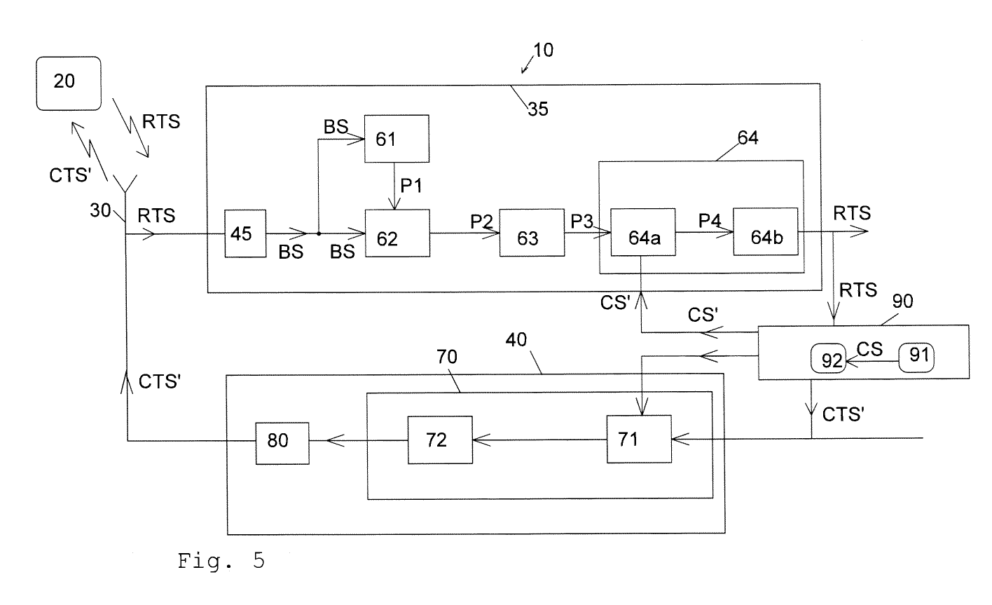

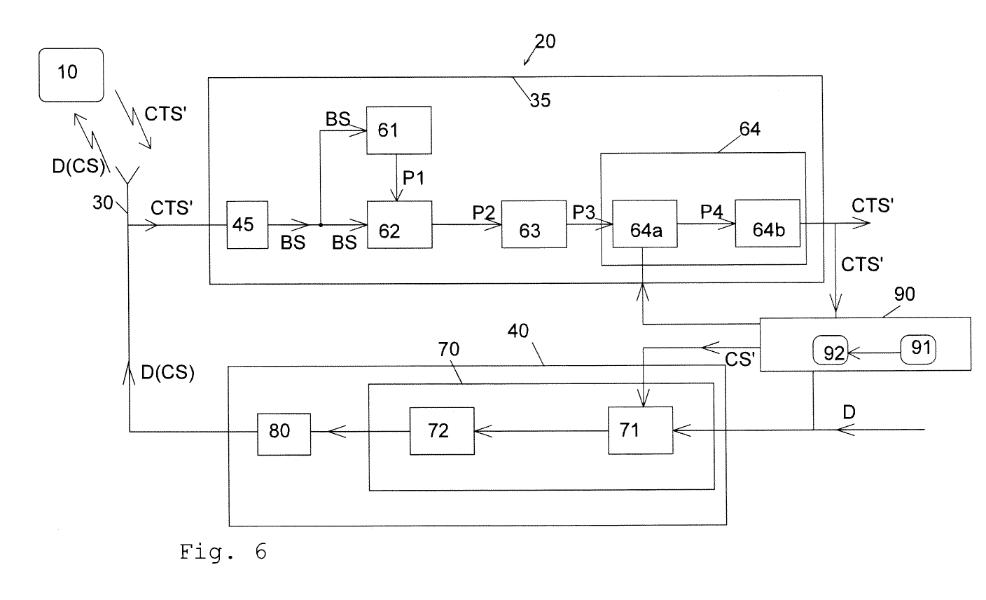

The devices 10 and 20 as shown in FIG. 1 may operate in various different modes. For further explanation, it is assumed in an exemplary fashion that both devices 10 and 20 use a RTS/CTS-mode (RTS/CTS: Request-To-Send/Clear-To-Send). In this case, the communication may be carried out as explained with reference to FIGS. 5 and 6.

FIG. 5 shows the device 10 according to FIG. 1, after the device 20 has sent a RTS (Request-To-Send) signal to the device 10. At this stage, both devices 10 and 20 have not yet agreed on a specific code structure. Thus, the device 20 sends the RTS-signal based on a predefined default code structure.

The device 10 and its control unit 90 receive the RTS-signal. The control unit 90 analyzes the RTS-signal, and selects a code structure on a random basis using its code structure selection unit 91. The randomly selected code structure is designated by reference numeral CS in FIG. 5.

The code structure CS is preferably selected individually for each transceiver pair (ad hoc mobile device pair). For communication with other devices than the second device 20, the first device 10 preferably chooses different code structures. As a result, an individual code structure is used for each link, and gain amplification of interfering signals at the decoder stage is avoided or at least reduced.

After selecting the code structure CS, a code structure signal unit 92 of the control unit 90 generates a modified CTS-signal CTS′ which includes the usual CTS-information “clear to send” and additionally a code structure indication which identifies the selected code structure CS.

The transmitter 40 sends the modified CTS-signal CTS′ to the second device 20 using the predefined default code structure.

As the control unit 90 of the device 10 expects the second device 20 to transmit at least one further data signal based on the code structure CS, it sends a corresponding code structure selection signal CS′ to the soft-input-soft-output decoder 64a in order to switch the soft-input-soft-output decoder 64a into a decoding mode that allows decoding based on the selected code structure CS.

For the exemplary embodiment discussed herein, it is assumed that the second device 20 might be identical or at least similar to the device 10. As such, the description of the first device 10 applies to the second device 20 mutatis mutandis. Therefore, in FIG. 6, the same reference numerals have been used to visualize the internal components of the second device 20.

FIG. 6 shows the second device 20 during communication with the first device 10 in further detail after the modified CTS-signal CTS′ has been sent from the first device 10 to the second device 20.

The control unit 90 of the second device 20 identifies the “clear-to-send”-information contained in the modified CTS-signal CTS′, and the additionally indication of the selected code structure CS. Then, the control unit 90 sends a code structure selection signal CS′ indicating the selected code structure CS to its decoder 71 in order to switch it to the respective code structure CS. From that point on, the decoder 71 will use the respective code structure CS for encoding further data D during communication with the first device 10. The encoded data D(CS) are transmitted towards the first device 10.

In the manner described above, each pair of ad hoc mobile devices and each channel may use its individual code structure. In case of interference, the interfering signal will have no, or at least no significant, correlation with the wanted signal and the interfering signal will not experience decoding gain.

### REFERENCE SIGNS

10 first ad hoc mobile device
20 second ad-hoc mobile device
25 physical transmission channel
30 antenna
35 receiver
40 transmitter
45 down-converter unit
61 channel estimator
62 equalizer
63 demapper
64 decoder
64a soft-input-soft-output decoder unit
64b converter unit
70 encoding unit
80 up-converter unit
90 control unit
91 structure selection unit
92 code structure signal unit
BS baseband complex symbol stream
CS code structure
CS′ code structure selection signal
CSSS code structure selection signal
CTS′ modified CTS-signal
D data
D(CS) encoded data
DS outgoing data bitstream
EDS outgoing baseband complex symbol stream
IS incoming joint signal
P1 estimated channel samples
P2 equalized symbol stream
P3 log-likelihood ratio stream
P4 decoded log-likelihood ratio stream
RTS RTS-signal
S1 joint signal
S2 interference (interfering) signal
S3 wanted signal
S4 noise
TS transmission signal (encoded and modulated bitstream)

What is claimed is:

1. Ad hoc mobile device capable of transmitting and receiving data in an ad-hoc network, comprising
a receiver capable of receiving and decoding an encoded signal which is transmitted over a physical transmission channel, wherein said receiver is able to handle at least two different code structures;
a transmitter capable of generating and transmitting an encoded signal, wherein said transmitter is able to handle at least two different code structures; and
a control unit which is connected to said receiver and said transmitter, said control unit being able to change the code structure currently used by the receiver and the transmitter.

2. Ad hoc mobile device of claim 1
wherein said device is configured to agree with another ad hoc mobile device on an individual code structure to be used for further communication.

3. Ad hoc mobile device of claim 2
wherein said device is configured to establish a data connection with another ad hoc mobile device based on a predefined default code structure, and to switch from the default code structure to a different individual code structure thereafter to transmit or receive a decoded signal to/from the other ad hoc mobile device based on said different individual code structure.

4. Ad hoc mobile device of claim 3
wherein said device is configured to select said different code structure and to signal the selected code structure to the other ad hoc mobile device for the subsequent data transfer.

5. Ad hoc mobile device of claim 3
wherein said device is configured to receive a control signal that defines said different code structure, from the other ad hoc mobile device, and to switch its receiver to said different code structure for further data reception.

6. Ad hoc mobile device of claim 1 wherein the device is configured to change the code structure by selecting a code polynomial out of a plurality of predefined code polynomials.

7. Ad hoc mobile device of claim 1 wherein the device is configured to change the code structure by selecting a turbo-interleaver or a turbo-deinterleaver out of a plurality of predefined turbo-interleavers or turbo-deinterleavers.

8. Ad hoc mobile device of claim 1 wherein the device is configured to change the code structure by selecting a channel-interleaver or a channel-deinterleaver out of a plurality of predefined channel-interleavers or channel-deinterleavers.

9. Ad hoc mobile device of claim 1 wherein the device is configured to change the code structure by selecting a channel class out of a plurality of predefined channel classes.

10. Ad hoc mobile device of claim 1 wherein the device is configured to change the code structure based on a scrambling process.

11. Ad hoc mobile device of claim 1 wherein the device is configured to change the code structure based on a permutation process for subcarrier mapping.

12. Ad hoc mobile device of claim 1
wherein said receiver comprises a decoder capable of handling said at least two different code structures;
wherein said transmitter comprises an encoder capable of handling said at least two different code structures; and
wherein said control unit is connected to said encoder and said decoder to change the code structure currently used by the encoder and the decoder.

13. Ad hoc mobile device of claim 1 further capable of communicating based on a RTS/CTS scheme wherein the device is capable of sending a Clear-To-Send(CTS) Request to another ad hoc mobile device after receiving a Request-To-Send(RTS)-signal from said other ad hoc mobile device, said Request-To-Send(RTS)-signal being sent based on a default code structure and containing information defining a different code structure for further data transfer.

14. Ad-hoc network comprising at least two ad hoc mobile devices according to claim 1.

15. Ad-hoc network according to claim 1 wherein said at least two ad hoc mobile devices communicate with each other based on a code structure previously agreed on.

16. Method of handling a data connection between a first and a second ad hoc mobile device, the method comprising the steps of:
establishing a data connection between said first and said second ad hoc mobile device based on a predefined default code structure;
agreeing on a different individual code structure; and
switching said first and said second ad hoc mobile device from the default code structure to said different individual code structure in order to transmit or receive a decoded signal based on said different individual code structure.
